(19) United States
(12) Patent Application Publication
(10) Pub. No.: US 2005/0270424 A1
(43) Pub. Date: Dec. 8, 2005

(54) Method for viewing televised events

(76) Inventor: Zamir Manor, Rishon-Le-Zion (IL)

Correspondence Address: BROWDY AND NEIMARK, P.L.L.C.;624 NINTH STREET, NW, SUITE 300, WASHINGTON, DC, 20001-5303, US

(21) Appl. No.: 10/523,922

(22) PCT Filed: Aug. 6, 2003
(86) PCT No.: PCT/IL03/00644

§ 371 Date: Feb. 7, 2005

(30) Foreign Application Priority Data
Aug. 7, 2002 (IL) 151118

(51) Int. Cl. H04N 5/445

(52) U.S. Cl. 348/564

(57) ABSTRACT

A method for viewing a televised event. The televised event includes a few competing parties (12, 13) wherein each party has a uniform that is visually distinguished in respect of the uniform of any other party of the other parties. The televised event includes a score indication (11) with score portion for each party. The method includes receiving a processed televised event for display on a display device (10). The score indication portions are colored so as to facilitate visual association of each score indication portion to a respective party according to the color of the uniform of the party.

### FIELD OF THE INVENTION

The present invention is in the general field of viewing sporting events such as football, soccer, baseball, basketball and other games.

### BACKGROUND OF THE INVENTION

Viewing sporting events on television has become very popular, as the average spectator can view a game or competition in the comfort of her home, and due to modern technology, can also benefit from high quality sound and images. Thus, due to today's modern equipment, e.g., high resolution large screen TVs equipped with a surround audio system, the excitement and sensation of a sports competition can be brought into the viewer's home, as if she actually attended the event as a spectator.

Needless to say, viewing at home obviates the long trip to the stadium, as well as waiting in line to purchase tickets, and obviously the inconvenience of having to withstand prevailing temperatures when an event takes place during cold or hot weather conditions.

Bearing all this in mind, and considering also the popularity of some of the sports such as soccer, it is no surprise that the common estimate is that nearly two billion people viewed the televised Mondial 2002 Tournament that took place in Japan and South Korea.

Modern TV technology, in particular digital TV broadcasting, enables not only to view in high quality a particular sporting event, but also to apply numerous functions to the so-viewed events such as replays, freezing a frame of interest and providing instantaneous statistics on the screen that relate to an ongoing action using, e.g., interactive commands activated by means of the television remote control. With the introduction of improved technologies, both at the broadcasting end as well as in the television receiving unit, more and more options are constantly being introduced to further enhance the viewer's enjoyment from the viewed sporting event.

The wide range of options discussed above, still do not cope with a typical scenario which, in many cases, causes frustration to the common viewer. Consider for example (with reference to FIG. 1), a soccer match is being shown on the viewer's TV screen (10), which has started at say, 19:00, and the viewer turns on her television set and 19:10, and notices from the score indication (11) that the score is one-nil in team B's favor. This obviously means that team B managed to score a goal during the first ten minutes of the game missed by the viewer.

Assuming also that the viewer cannot identify from the football players' uniforms which is team B, i.e., in the example of FIG. 1, it is not clear whether the team with the uniform consisting of black shorts and striped shirts (12) is the leading team, or whether the team with the uniform consisting of white shorts and checkered shirts (13) is the leading team. This, obviously, causes a lot of frustration to the viewer who is naturally interested in knowing who is the leading team. In some cases, it may take several minutes, or even longer, until the viewer actually becomes aware of the scores of each respective team. For example, the viewer may only become aware of the score of the game after the commentator provides information as to which side is the leading side, or, for another example, when one of the teams scores another goal, and in response, the score indication (11) is updated on the screen, enabling the viewer to see the latest score and become aware of which team was leading until the latest goal. Whereas the example of FIG. 1 refers to a scenario where one team leads, the need to identify the participating teams obviously arises also in the case of draw, say 0:0, since the viewer naturally wants to identify which team is team A and which team is team B.

In other sports, such as basketball, the score is updated more frequently. However, still, the common viewer would like to know on the spot upon turning on her TV receiver, who is currently winning. It is true that in many cases the viewer is familiar with the uniforms of both teams (e.g., when her favorite team is participating) or the players themselves, and therefore can identify on the spot, without any additional assistance, who is the leading team, (e.g., in the case of FIG. 1, she is well familiar with the uniform of Team B/A and/or with the players), and as she turns on the TV, she will know who is leading. However, in many cases this is not true. For example, even for her favorite team, it may well be the case, that for a particular match, uniforms were changed, or, for example, the viewer is watching a soccer game between two teams with whom the viewer is familiar, however, not to the extent that she can readily identify the team by their uniform.

There is accordingly a need in the art to overcome this limitation in televised sporting events, by facilitating an immediate means of identifying which from among the two teams is the losing one and the winning one.

### SUMMARY OF THE INVENTION

In the context of the invention, the term televised sporting event should be construed in a broad sense, encompassing viewing sporting events via a television screen, computer monitor, being non-limiting examples of a displaying device. The invention encompasses viewing broadcast sporting events and/or time-shifted sporting events. For convenience, the description refers to the specific example of a soccer game with two competing teams. Those versed in the art will readily appreciate that the invention is by no means bound to this particular example, and accordingly, any other sport event, including, but not limited to American Football, Rugby, Baseball, Basketball, Volleyball is applicable. Likewise, the invention is not bound to only sporting events having two competing teams, but any number of competing teams, all depending on the sport events. Still further, whereas the specific examples focus on competing teams, this is only one example of competing parties. Thus, by another example each competing party is a single participant.

Those versed in the art will further appreciate that the proposed invention may likewise be applicable to other competitions or games, not necessarily confined to sport (e.g., televised quiz shows with several participating teams, each identified by a respective uniform).

Note, that the term uniform should be construed in an broad manner, encompassing one or more garments worn by the player, including but not limited to, shirts, shorts/pants, socks, shoes, headbands, wristbands, vests, etc. It also applies to garment accessories (sewn on or attached to a garment).

Score component should be construed in a broad manner. Thus, in case of letters and numbers the letter/number's background may be colored in addition or instead the letter/number. By another non-limited example it may be a symbol or symbols following or preceding the letters. Other examples are applicable all depending upon the particular application.

Accordingly, the invention provides for a method for viewing a televised event, the televised event includes at least two competing parties wherein each party has a uniform that is visually distinguished in respect of the uniform of any other party of said at least two parties; the televised event includes a score indication with score portion for each party; the method comprising:
receiving a processed televised event for display on a display device; the score indication portions are colored so as to facilitate visual association of each score indication portion to a respective party according to the color of the uniform of said party.

The invention further provides for a method for preparing for viewing a televised event, the televised event includes at least two competing parties wherein each party has a uniform that is visually distinguished in respect of the uniform of any other party of said at least two parties; the televised event includes a score indication with score portion for each party; the method comprising:
processing the televised event for display on a display device; the processing included: coloring the score indication portions so as to facilitate visual association of each score indication portion to a respective party according to the color of the uniform of said party.

Still further, the invention provides for a method for viewing a televised event, the televised event includes at least two competing parties wherein each party has a uniform that is visually distinguished in respect of the uniform of any other party of said at least two parties; the televised event includes a score indication with score portion for each party, the score portion includes, each, score components; the method comprising:
receiving a processed televised event for display on a display device; at least one of said score components is colored so as to facilitate visual association of the score indication portion to a respective party according to the color of the uniform of said party.

Yet further, the invention provides for a method for viewing a televised event, the televised event includes at least two competing parties wherein each party has a uniform that is visually distinguished in respect of the uniform of any other party of said at least two parties; the televised event includes a score indication with score portion for each party; the score portion includes, each, score components; the method comprising:
processing the televised event for display on a display device; the processing included: coloring at least one of said score components so as to facilitate visual association of each score indication portion to a respective party according to the color of the uniform of said party.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates schematically a still frame taken from a televised broadcast of a soccer game between Team A and Team B, according to the prior art.

FIGS. 2A-B illustrates schematically a still frame taken from a televised broadcast of a soccer game between Team A and Team B, according to an embodiment of the invention; and

FIG. 3 illustrates a generalized block diagram of the operational steps for implementing the viewing method of the invention.

### DETAILED DESCRIPTION OF TH INVENTION

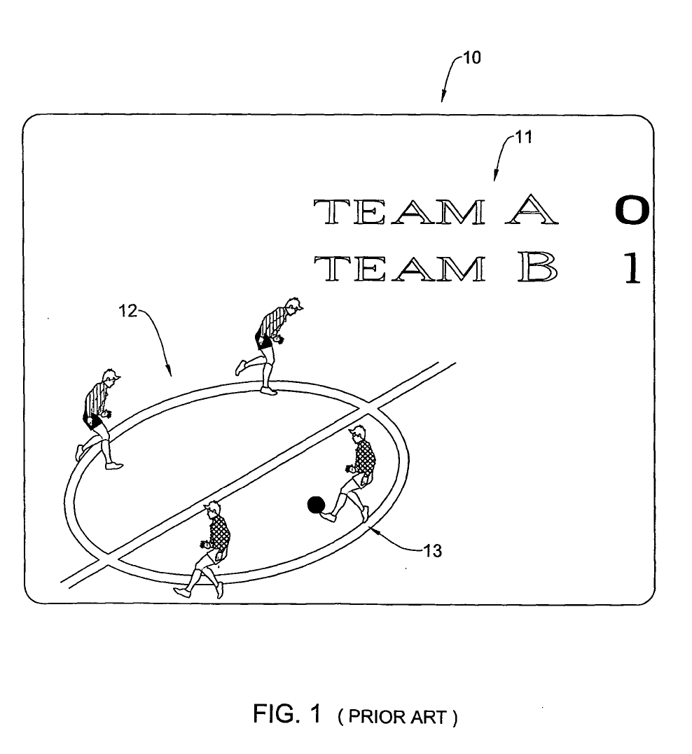

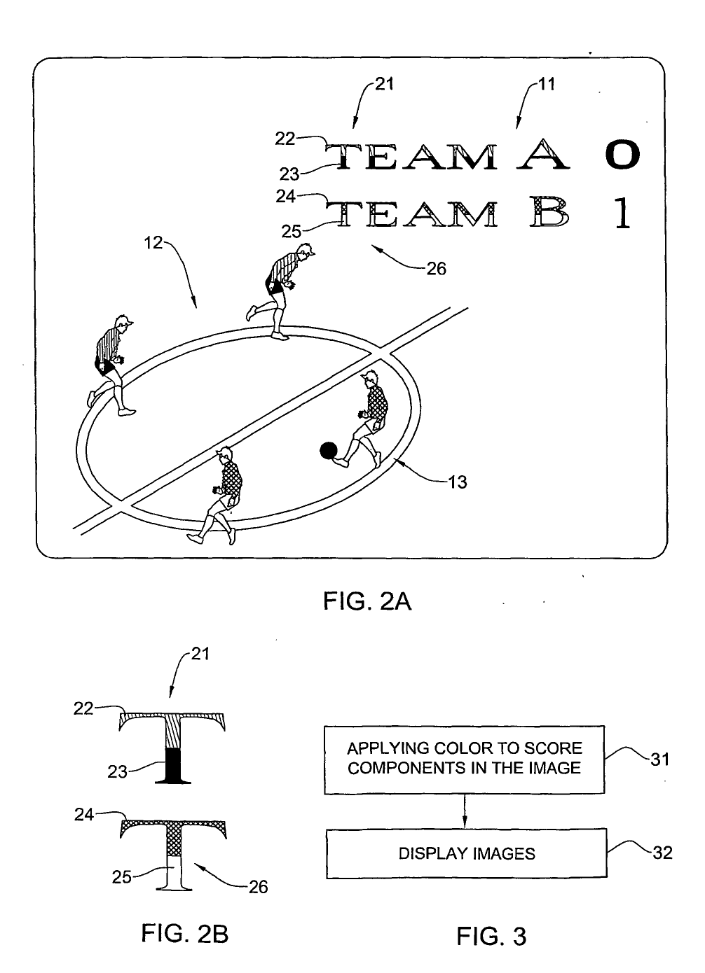

Attention is now drawn to FIGS. 2A-B illustrating, schematically, a still frame taken from a televised broadcast of a soccer game between Team A and Team B, according to an embodiment of the invention. The still frame and the score indication of FIG. 2A are basically identical to that illustrated in FIG. 1 and therefore they have been designated the same reference numerals.

In accordance with this embodiment of the invention, one or all of the score indication components, e.g. the score indication fonts of each party (e.g. team) has a color that uniquely identifies the uniform of its respective party. Color, in the context of the invention, should be construed as a single color or combination of two or more colors in any desired pattern. Thus, in the embodiment of FIG. 2A, the lettering (being an example of a score indication component) of TEAM A has a color identical to that of the uniform of TEAM A. For example, the upper portion of the letter T (21) of TEAM is striped (22) and the lower portion thereof is black (23), being in this case of the same color and pattern as that of the respective shirts and shorts of the uniform of the players (12) of TEAM A. By this particular example, the same color is repeated for each letter constituting the score indication part of TEAM A. Note that for clarity, the T letters of Team A and N are depicted in larger scale in FIG. 2B

As shown in FIG. 2A, the same applies to the score components of the score indication portion of TEAM B, see e.g., the upper portion of the letter T of TEAM is checkered (24) and the lower portion thereof is white (25), being in this case, of the same color and pattern as that of the respective shirts and shorts of the uniform of the players (13) of TEAM B. This example illustrates in a non limiting manner a situation where the color of the score components of the score indication portion of TEAM A are identical to the color of the uniform of TEAM A, i.e. by this example the color of the shirt and the shorts are reflected in the score components.

Using the proposed technique of the invention as illustrated in the example of FIG. 2, will facilitate the viewer to readily associate the score to the respective uniforms of the playing parties (in this case the playing teams) and to thus be updated as to the current state of the game and more specifically, as to who is the leading/losing side.

Those versed in the art will readily appreciate that the invention is by no means bound to the specific example illustrated in FIG. 2. By way of a non-limiting example, not all of the score components are depicted in a color that corresponds to the uniform of the respective team. For example, the color may extend to only the initials (i.e. the letters T in FIG. 2) or to the score numbers (i.e. the ‘1’ and ‘0’) whereas the other score components (i.e., by this example the other letters and the score numbers) are neutral (e.g. all in white color). The viewer will be able to associate the score to the teams by viewing the colored lettering. Other variants where not all the score components are colored in correspondence to the party's uniforms are applicable, all as desired and appropriate. This example illustrates in a non limiting manner a situation where the color of the score components of the score indication portion of TEAM A are non identical to the color of the uniform of TEAM A, i.e. by this example some score components have a color different than the color of the shirt and the shorts.

By way of another non-limiting example, the color of the score components and that of the uniforms may not necessarily be identical but rather similar enough to facilitate unique identification. For example, the striped color for TEAM A extends to the entire score component (in contrast to extending to only the upper half in FIG. 2, see the upper portion 22 of the letter T of TEAM A) and the checkered color for TEAM B extends to the entire score component (in contrast to extending to only the upper half in FIG. 2, see the upper portion 24 of the letter T of TEAM B). Note that the striped pattern versus the checkered pattern are sufficient to uniquely identify the uniforms of the TEAM A and TEAM B. This example illustrates in a non limiting manner another situation where the color of the score components of the score indication portion of TEAM A are non identical to the color of the uniform of TEAM A.

The various alternative embodiments described above are only few out of many possible variants for using colored score indication in order to facilitate immediate identification of the participating parties. Note that other desired assisting means may be utilized, e.g. portraying the club symbol near its respective name. Thus, for example, the letter T (21) may be preceded by the club symbol of TEAM A and, likewise, the letter T (26) may be preceded by the club symbol of TEAM B.

Attention is now drawn to FIG. 3, illustrating a generalized block diagram of the operational steps for implementing the viewing method of the invention. Thus, the images, e.g. a succession of video frames are processed (31) to apply color to the score indication such that the color corresponds to the color of the uniform of the respective party, all as explained in detail above, with reference to FIG. 2. There are numerous known per se techniques to apply color in the manner specified. The so-processed images are then displayed (32) on the screen of the displaying device, e.g. TV, computer screen, etc. Note that FIG. 3 illustrates the process in a generalized manner and known per se steps are not illustrated herein. For example, the processing may take place at a broadcasting station and the processed images are then broadcast, received by the display device processed therein and displayed on its screen. Other variants are applicable, all depending on the particular application.

The present invention has been described with a certain degree of particularity, but those versed in the art will readily appreciate that various alterations and modifications may be carried out without departing from the scope of the following claims:

1. A method for viewing a televised event, the televised event includes at least two competing parties wherein each party has a uniform that is visually distinguished in respect of the uniform of any other party of said at least two parties; the televised event includes a score indication with score portion for each party; the method comprising:
receiving a processed televised event for display on a display device; the score indication portions are colored so as to facilitate visual association of each score indication portion to a respective party according to the color of the uniform of said party.

2. The method according to claim 1, wherein said event being a sport event.

3. The method according to claim 2, wherein said sport event includes two parties each being a team of players.

4. The method according to claim 3, wherein said sport event being anyone of soccer, American football, basketball, baseball, Rugby and volleyball.

5. The method according to anyone of the preceding claims, wherein score indication portions are colored each in an identical color as the uniform of said respective party, facilitating visually association of each score indication portion to its respective party.

6. The method according to claim 1, wherein score indication portions are colored each in non identical color as that of the uniform of said respective party, facilitating visually association of each score indication portion to its respective party.

7. A method for preparing for viewing a televised event, the televised event includes at least two competing parties wherein each party has a uniform that is visually distinguished in respect of the uniform of any other party of said at least two parties; the televised event includes a score indication with score portion for each party; the method comprising:
processing the televised event for display on a display device; the processing included: coloring the score indication portions so as to facilitate visual association of each score indication portion to a respective party according to the color of the uniform of said party.

8. The method according to claim 7, wherein said event being a sport event.

9. The method according to claims 7 or 8, wherein said sport event includes two parties each being a team of players.

10. The method according to claim 9, wherein said sport event being anyone of soccer, American football, basketball, baseball, Rugby and volleyball.

11. The method according to claim 6, wherein score indication portions are colored each in an identical color as the uniform of said respective party, facilitating visually association of each score indication portion to its respective party.

12. The method according to claim 6, wherein score indication portions are colored each in non identical color as that of the uniform of said respective party, facilitating visually association of each score indication portion to its respective party.

13. A method for viewing a televised event, the televised event includes at least two competing parties wherein each party has a uniform that is visually distinguished in respect of the uniform of any other party of said at least two parties; the televised event includes a score indication with score portion for each party; the score portion includes, each, score components; the method comprising:
receiving a processed televised event for display on a display device; at least one of said score components is colored so as to facilitate visual association of the score indication portion to a respective party according to the color of the uniform of said party.

14. The method according to claim 13, wherein said score portion includes the party name and the score value component being either a letter or a font that constitute the score portion.

15. The method according to claims 13 or 14, wherein said event being a sport event.

16. The method according to claim 15, wherein said sport event includes two parties each being a team of players.

17. The method according to claim 16, wherein said sport event being anyone of soccer, American football, basketball, baseball, Rugby and volleyball.

18. The method according to claim 13, wherein at least one of said score components is colored in an identical color as the uniform of said respective party, facilitating visually association of each score indication portion to its respective party.

19. The method according to claim 13, wherein at least one of said score components is colored in a non identical color as the uniform of said respective party, facilitating visually association of each score indication portion to its respective party.

20. A method for viewing a televised event, the televised event includes at least two competing parties wherein each party has a uniform that is visually distinguished in respect of the uniform of any other party of said at least two parties; the televised event includes a score indication with score portion for each party; the score portion includes, each, score components; the method comprising:
processing the televised event for display on a display device; the processing included: coloring at least one of said score components so as to facilitate visual association of each score indication portion to a respective party according to the color of the uniform of said party.

21. The method according to claim 20, wherein said score portion includes the party name and the score value component being either a letter or a font that constitute the score portion.

22. The method according to claims 20 or 21, wherein said event being a sport event.

23. The method according to claim 22, wherein said sport event includes two parties each being a team of players.

24. The method according to claim 23, wherein said sport event being anyone of soccer, American football, basketball, baseball, Rugby and volleyball.

25. The method according to claim 20, wherein at least one of said score components is colored in an identical color as the uniform of said respective party, facilitating visually association of each score indication portion to its respective party.

26. The method according to claim 20, wherein at least one of said score components is colored in a non identical color as the uniform of said respective party, facilitating visually association of each score indication portion to its respective party.
